(19) United States
(12) Patent Application Publication
(10) Pub. No.: US 2026/0058725 A1
(43) Pub. Date: Feb. 26, 2026

(54) OPTICAL POWER DISTRIBUTION ESTIMATION APPARATUS, OPTICAL POWER DISTRIBUTION ESTIMATION METHOD, AND COMPUTER PROGRAM

(71) Applicant: NTT, Inc., Tokyo (JP)

(72) Inventors: Takeo SASAI, Musashino-shi (JP); Etsushi YAMAZAKI, Musashino-shi (JP); Hideki NISHIZAWA, Musashino-shi (JP); Yoshiaki SONE, Musashino-shi (JP); Yoshiaki KISAKA, Musashino-shi (JP)

(73) Assignee: NTT, Inc., Tokyo (JP)

(21) Appl. No.: 19/103,566

(22) PCT Filed: Sep. 13, 2022
(86) PCT No.: PCT/JP2022/034209

§ 371 Date: Feb. 13, 2025

(51) Int. Cl. H04B 10/079

(52) U.S. Cl. CPC H04B 10/07955

(57) ABSTRACT

An optical power distribution estimation device includes: an optical power distribution estimation unit that estimates an optical power distribution on the basis of a reception signal based on an optical signal transmitted from an optical transmission device and received via an optical transmission line and a transmission signal restored based on the reception signal; a spatial response function calculation unit that calculates a spatial response function on the basis of the transmission signal and a dispersion value of the optical transmission line; and a digital filter application unit that obtains an ideal output by applying a digital filter based on the spatial response function to the optical power distribution.

### TECHNICAL FIELD

The present invention relates to an optical power distribution estimation device, an optical power distribution estimation method, and a computer program.

### BACKGROUND ART

When an optical transmission system is operated, basic characteristics of an optical fiber forming an optical transmission line greatly affect transmission performance. Here, the basic characteristics of the optical fiber include optical power, distributions of loss and dispersion, and a position of a fault point. For example, when the optical power is too large, an influence of a nonlinear optical effect in the optical fiber increases. Therefore, a signal-to-noise ratio (hereinafter, referred to as “SNR”) decreases. When the loss is too large, attenuation of the optical power increases accordingly, and the SNR decreases.

Therefore, it is important to know the characteristics of the optical fiber in operation, maintenance, and monitoring of the optical transmission system. The optical transmission line includes various devices in addition to the optical fiber, such as an optical amplifier and an optical filter. It is also important to know characteristics of those devices in operation, maintenance, and monitoring of the optical transmission system.

The characteristics of the optical fiber and the devices such as the optical amplifier and the optical filter can be generally measured by an analog measuring instrument such as an optical time domain reflectometer (OTDR) or an optical spectrum analyzer. However, in measurement using the analog measuring instrument, it is necessary to perform direct measurement on each optical node or each optical fiber, which increases an equipment cost and an operating cost.

In order to solve the above problem, digital longitudinal monitoring (DLM), which is a technique for detecting characteristics of various devices in the optical transmission system by digital signal processing on a reception side of the optical transmission system, has been proposed in recent years, instead of measurement using the analog measuring instrument (see, for example, Non Patent Literatures 1 and 2). The DLM is based on a digital coherent optical transmission system and performs digital signal processing on a reception signal obtained by performing coherent detection on an optical signal transmitted through the optical transmission line, thereby monitoring optical power or the like that is a characteristic of the optical transmission line.

### CITATION LIST

### Non Patent Literature

Non Patent Literature 1: T. Tanimura, et al., “Fiber-Longitudinal Anomaly Position Identification Over Multi-Span Transmission Link Out of Receiver-end Signals”, JLT, 38(9), 2020.
Non Patent Literature 2: T. Sasai, et al., “Digital longitudinal monitoring of Optical Fiber Communication Link”, JLT, 40(8), 2022.

### SUMMARY OF INVENTION

### Technical Problem

However, in an optical power distribution estimation technique by the conventional digital signal processing, simple measurement can be performed as compared with an analog measuring instrument, but there is a problem that spatial resolution and estimation accuracy are low.

In view of the above circumstances, an object of the present invention is to provide a technique capable of estimating an optical power distribution having high spatial resolution with high accuracy in an optical power distribution estimation technique by digital signal processing.

### Solution to Problem

An aspect of the present invention is an optical power distribution estimation device including: an optical power distribution estimation unit that estimates an optical power distribution on the basis of a reception signal based on an optical signal transmitted from an optical transmission device and received via an optical transmission line and a transmission signal restored based on the reception signal; a spatial response function calculation unit that calculates a spatial response function on the basis of the transmission signal and a dispersion value of the optical transmission line; and a digital filter application unit that obtains an ideal output by applying a digital filter based on the spatial response function to the optical power distribution.

An aspect of the present invention is an optical power distribution estimation method including: estimating an optical power distribution on the basis of a reception signal based on an optical signal transmitted from an optical transmission device and received via an optical transmission line and a transmission signal restored based on the reception signal; calculating a spatial response function on the basis of the transmission signal and a dispersion value of the optical transmission line; and obtaining an ideal output by applying a digital filter based on the spatial response function to the optical power distribution.

An aspect of the present invention is a computer program for causing a computer to execute: an optical power distribution estimation step of estimating an optical power distribution on the basis of a reception signal based on an optical signal transmitted from an optical transmission device and received via an optical transmission line and a transmission signal restored based on the reception signal; a spatial response function calculation step of calculating a spatial response function on the basis of the transmission signal and a dispersion value of the optical transmission line; and a digital filter application step of obtaining an ideal output by applying a digital filter based on the spatial response function to the optical power distribution.

### Advantageous Effects of Invention

According to the present invention, it is possible to estimate an optical power distribution having high spatial resolution with high accuracy in an optical power distribution estimation technique by digital signal processing.

### BRIEF DESCRIPTION OF DRAWINGS

FIG. 1 An explanatory diagram of an optical power distribution estimated by using a conventional correlation method.

FIG. 2 A diagram illustrating a configuration example of an optical reception device according to a first embodiment.

FIG. 3 A flowchart showing a flow of processing of the optical reception device according to the first embodiment.

FIG. 4 A diagram illustrating a configuration example of an optical transmission system according to a modification example of the first embodiment.

FIG. 5 A diagram illustrating a configuration example of an optical reception device according to a second embodiment.

FIG. 6 A flowchart showing a flow of processing of the optical reception device according to the second embodiment.

FIG. 7 A diagram illustrating a configuration example of an optical transmission system according to a modification example of the second embodiment.

FIG. 8 A diagram illustrating a configuration example of an optical reception device according to a third embodiment.

FIG. 9 A diagram illustrating a configuration example of a digital filter application unit according to the third embodiment.

### DESCRIPTION OF EMBODIMENTS

Hereinafter, embodiments of the present invention will be described with reference to the drawings.

### Overview

First, an overview of the present invention will be described. In the present invention, a digital filter is designed for an optical power distribution estimation result obtained by a method proposed as an optical power distribution estimation technique, and the designed digital filter is convolved with the optical power distribution estimation result to obtain an ideal output. Here, the method proposed as the optical power distribution estimation technique is, for example, a correlation method and least squares method. Hereinafter, specific configurations for achieving the above processing will be described by using those methods.

### First Embodiment

In a first embodiment, a configuration for estimating an optical power distribution by using a conventional correlation method will be described. Here, the conventional correlation method is, for example, a method disclosed in Non Patent Literature 1. An optical power distribution ˜γ′(zₖ) estimated by the conventional correlation method is shown in Equation (1) below. The symbol “˜” is attached above γ′. The symbol zₖ denotes a measurement position of optical power on an optical transmission line. The symbol x∘c (x is written in the circle) in Equation (1) denotes a symbol of continuous convolution. The optical transmission line is, for example, an optical fiber.

$$\begin{matrix}[ Math . 1 ] & \\ {\tilde{γ}}^{′} ( {z}_{k} ) = {P}_{0} + 2 ε \cdot ( {γ}^{′} {⊗}_{c} {g}_{Re} ) ( {z}_{k} ) & Equation ( 1 )\end{matrix}$$

In Equation (1), P₀ denotes power (constant) of a signal used in the correlation method, ε denotes a real number arbitrarily set by a user, γ′ denotes γP(z), γ denotes a nonlinear constant (W⁻¹ km⁻¹), P(z) denotes a true optical power distribution (estimation target) in the optical transmission line, and g_{Re}(z) denotes a spatial response function. Here, the spatial response function g_{Re}(z) is shown in Equation (2) below.

$$\begin{matrix}[ Math . 2 ] & \\ {g}_{Re} ( z ) = Re [ {\hat{D}}_{0 z} [ \hat{N} [ {\hat{D}}_{z 0} [ {ρ}_{m} [ A [ n ] , A [ n ] ] ] ] ] {\vert}_{m = 0} ] & Equation ( 2 )\end{matrix}$$

The symbols in Equation (2) are shown in Equations (3) to (5) below. The symbol A in Equation (2) denotes a transmission signal. The symbols β₂(z) and β₃(z) in Equation (3) denote dispersion values of the optical transmission line.

$$\begin{matrix}[ Math . 3 ] & \\ {\hat{D}}_{{z}_{1} {z}_{2}} [ \cdot ] ≡ {F}^{- 1} [ exp ( j ( \frac{{ω}^{2}}{2} {\int }_{{z}_{1}}^{{z}_{2}} {β}_{2} ( z ) dz + \frac{{ω}^{3}}{6} {\int }_{{z}_{1}}^{{z}_{2}} {β}_{3} ( z ) dz ) ) \cdot F [ \cdot ] ] , ( Wavelength dispersion operation ) & Equation ( 3 )\end{matrix}$$

$$\begin{matrix}[ Math . 4 ] & \\ \hat{N} = {\vert \cdot \vert}^{2} ( \cdot ) & Equation ( 4 )\end{matrix}$$

$$\begin{matrix}[ Math . 5 ] & \\ {ρ}_{m} [ A [ n ] , B [ n ] ] = E [ A * [ n ] B [ n + m ] ] ( Correlation operation ) & Equation ( 5 )\end{matrix}$$

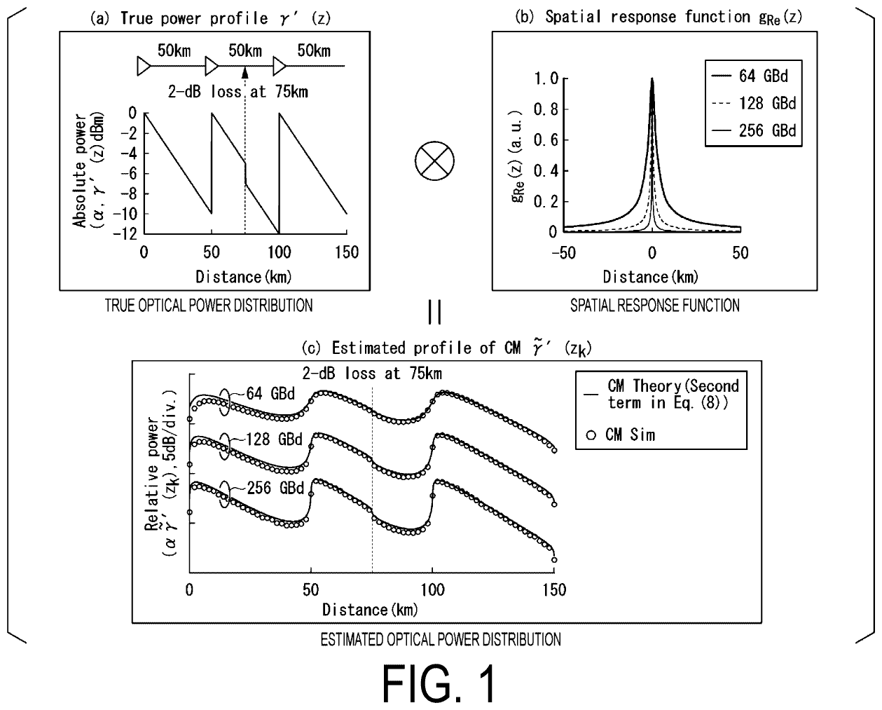

Based on the above content, it can be considered that an optical power distribution estimated by using the conventional correlation method is “convolution of a certain spatial response function g_{Re}(z) with a true optical power distribution γ′(z) (or one proportional thereto)” as shown in FIG. 1. Therefore, if the spatial response function g_{Re}(z) is known in advance, the true optical power distribution γ′(z) can be restored based on Equation (6) below.

$$\begin{matrix}[ Math . 6 ] & \\ {γ}^{′} ( z ) = \frac{1}{2 ε} ( {\tilde{γ}}^{′} {⊗}_{c} {g}_{Re}^{- 1} ) ( {z}_{k} ) & Equation ( 6 )\end{matrix}$$

The spatial response function g_{Re}(z) can be uniquely determined if the used transmission signal A[n] and the dispersion values β₂(z) and β₃(z) of the optical transmission line are known.

Hereinafter, a specific configuration for obtaining the true optical power distribution γ′(z) will be described on the basis of results based on the above consideration.

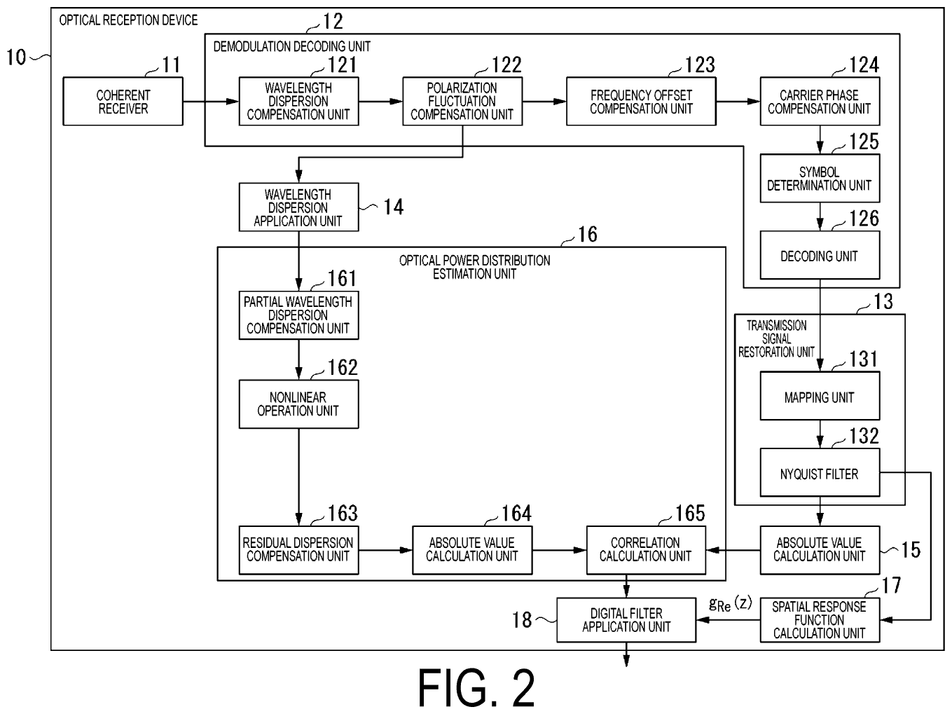

FIG. 2 shows a configuration example of an optical reception device 10 according to the first embodiment. The optical reception device 10 uses the correlation method as an estimation algorithm for estimating an optical power distribution. The optical reception device 10 is connected to an optical transmission device included in an optical transmission system via an optical transmission line. The optical reception device 10 receives a transmission signal transmitted from the optical transmission device via the optical transmission line. The optical reception device 10 includes a coherent receiver 11, a demodulation decoding unit 12, a transmission signal restoration unit 13, a wavelength dispersion application unit 14, an absolute value calculation unit 15, an optical power distribution estimation unit 16, a spatial response function calculation unit 17, and a digital filter application unit 18. Note that the transmission signal restoration unit 13, the wavelength dispersion application unit 14, the absolute value calculation unit 15, the optical power distribution estimation unit 16, the spatial response function calculation unit 17, and the digital filter application unit 18 are configured as an optical power distribution estimation device.

The coherent receiver 11 is connected to the optical transmission line and receives an optical signal (e.g. a transmission signal) transmitted through the optical transmission line to perform coherent detection. The coherent receiver 11 separates polarization of the received optical signal into X-polarization and Y-polarization. The coherent receiver 11 causes each of the X-polarization and Y-polarization optical signals after the polarization separation to interfere with laser light emitted from a local oscillation light source provided therein, thereby detecting the I-component and the Q-component of the X-polarization and the Y-polarization. The coherent receiver 11 converts the I-component and Q-component optical signals of the X-polarization and the Y-polarization into four series of analog electric signals. The coherent receiver 11 converts the converted four series of analog signals into four series of digital signals by using four analog-to-digital converters provided therein and outputs the four series of digital signals. Hereinafter, the four series of digital signals output from the coherent receiver 11 will be referred to as a reception signal.

The demodulation decoding unit 12 compensates for an influence caused by the optical transmission line with respect to the reception signal output from the coherent receiver 11 and decodes the reception signal. Examples of the influence caused by the optical transmission line include wavelength dispersion, polarization fluctuation, a frequency offset, and a carrier phase. The demodulation decoding unit 12 includes a wavelength dispersion compensation unit 121, a polarization fluctuation compensation unit 122, a frequency offset compensation unit 123, a carrier phase compensation unit 124, a symbol determination unit 125, and a decoding unit 126.

The wavelength dispersion compensation unit 121 estimates wavelength dispersion received in the optical transmission line and compensates for the estimated wavelength dispersion with respect to the reception signal output from the coherent receiver 11.

The polarization fluctuation compensation unit 122 compensates for distortion generated in a waveform of the reception signal in the optical transmission line by using the reception signal whose wavelength dispersion has been compensated for by the wavelength dispersion compensation unit 121. That is, the polarization fluctuation compensation unit 122 corrects a symbol error generated in the reception signal due to inter-symbol interference in the optical transmission line. For example, the polarization fluctuation compensation unit 122 may perform adaptive equalization processing by using a finite impulse response (FIR) filter according to a set tap coefficient. Note that the polarization fluctuation compensation unit 122 may compensate for the distortion generated in the waveform of the reception signal by a method other than the above which adaptively compensates for the polarization fluctuation.

The frequency offset compensation unit 123 compensates for a frequency offset with respect to the reception signal compensated by the polarization fluctuation compensation unit 122.

The carrier phase compensation unit 124 compensates for a phase offset with respect to the reception signal whose frequency offset has been compensated for.

The symbol determination unit 125 performs symbol determination on the reception signal whose phase offset has been compensated for.

The decoding unit 126 decodes the reception signal on the basis of a result of the symbol determination by the symbol determination unit 125.

The transmission signal restoration unit 13 restores a transmission signal by using the reception signal decoded by the demodulation decoding unit 12. That is, the transmission signal restoration unit 13 restores the transmission signal transmitted from the optical transmission device on the basis of the signal in which the influence caused by the optical transmission line has been compensated for. The transmission signal restoration unit 13 includes a mapping unit 131 and a Nyquist filter 132.

The mapping unit 131 maps the decoded reception signal. The Nyquist filter 132 restores a transmission signal by performing filter processing on the mapped reception signal.

The wavelength dispersion application unit 14 estimates wavelength dispersion received in the optical transmission line and applies a value of the estimated wavelength dispersion to the reception signal output from the polarization fluctuation compensation unit 122. Therefore, the reception signal is restored in which only the polarization fluctuation has been compensated for with respect to the signal output from the coherent receiver 11. The wavelength dispersion application unit 14 outputs the restored reception signal to the optical power distribution estimation unit 16.

The absolute value calculation unit 15 takes an absolute value of the transmission signal restored by the transmission signal restoration unit 13 and outputs the transmission signal whose absolute value has been taken to the optical power distribution estimation unit 16.

The optical power distribution estimation unit 16 estimates an optical power distribution (optical transmission characteristic) of the optical transmission line by the estimation algorithm based on the correlation method. The optical power distribution estimation unit includes a partial wavelength dispersion compensation unit 161, a nonlinear operation unit 162, a residual dispersion compensation unit 163, an absolute value calculation unit 164, and a correlation calculation unit 165.

The partial wavelength dispersion compensation unit 161 estimates partial wavelength dispersion corresponding to a distance from the optical reception device 10 to an optical power measurement position zₖ (k is a natural number of 0 or more) and compensates for the estimated partial wavelength dispersion with respect to the reception signal to which the value of the wavelength dispersion has been applied.

The nonlinear operation unit 162 performs nonlinear operation in Equation (7) below on the reception signal whose partial wavelength dispersion has been compensated for by the partial wavelength dispersion compensation unit 161. In Equation (7), uₒᵤₜ denotes an output from the nonlinear operation unit 162, and uᵢₙ denotes the reception signal to which the value of the partial wavelength dispersion has been applied.

$${u}_{out} = {u}_{in} \cdot exp ( - j ε ( {\vert {u}_{in , x} \vert}^{2} + {\vert {u}_{in , y} \vert}^{2} ) ) \qquad [ Math . 7 ]$$

$$( {u}_{in} = [ \begin{matrix}{u}_{in , x} \\ {u}_{in , y}\end{matrix} ] , {u}_{out} = [ \begin{matrix}{u}_{out , x} \\ {u}_{out , y}\end{matrix} ] , ε is arbitrary real number set by user )$$

### Equation (7)

The residual dispersion compensation unit 163 estimates residual wavelength dispersion corresponding to a distance from the optical power measurement position zₖ to an optical transmission device and compensates for the estimated residual wavelength dispersion with respect to the reception signal subjected to the nonlinear operation.

The absolute value calculation unit 164 takes an absolute value of the reception signal whose residual wavelength dispersion has been compensated for and outputs the reception signal whose absolute value has been taken to the correlation calculation unit 165.

The correlation calculation unit 165 correlates the transmission signal whose absolute value has been taken and which has been output from the absolute value calculation unit 15 with the reception signal whose absolute value has been taken and which has been output from the absolute value calculation unit 164. The optical power distribution estimation unit 16 performs this processing for each optical power measurement position. The correlation calculation unit 165 estimates the estimated power distribution ˜γ′(zₖ) by plotting a correlation result (correlation value) obtained for each optical power measurement position. The estimated power distribution ˜γ′(zₖ) estimated by the correlation calculation unit 165 is shown in Equation (1) above.

The spatial response function calculation unit 17 calculates the spatial response function g_{Re}(z) on the basis of Equation (2) above by using the restored transmission signal output from the transmission signal restoration unit 13.

The digital filter application unit 18 designs a digital filter g⁻¹_{Re}(z) by using the spatial response function g_{Re}(z) calculated by the spatial response function calculation unit 17. For example, the digital filter application unit 18 may obtain the digital filter g⁻¹_{Re}(z) by the least squares method or may obtain the digital filter g⁻¹_{Re}(z) according to the Zero-forcing coding. The digital filter application unit 18 obtains an ideal output by convolving the digital filter g⁻¹_{Re}(z) with the estimated power distribution ˜γ′(zₖ) estimated by the correlation calculation unit 165.

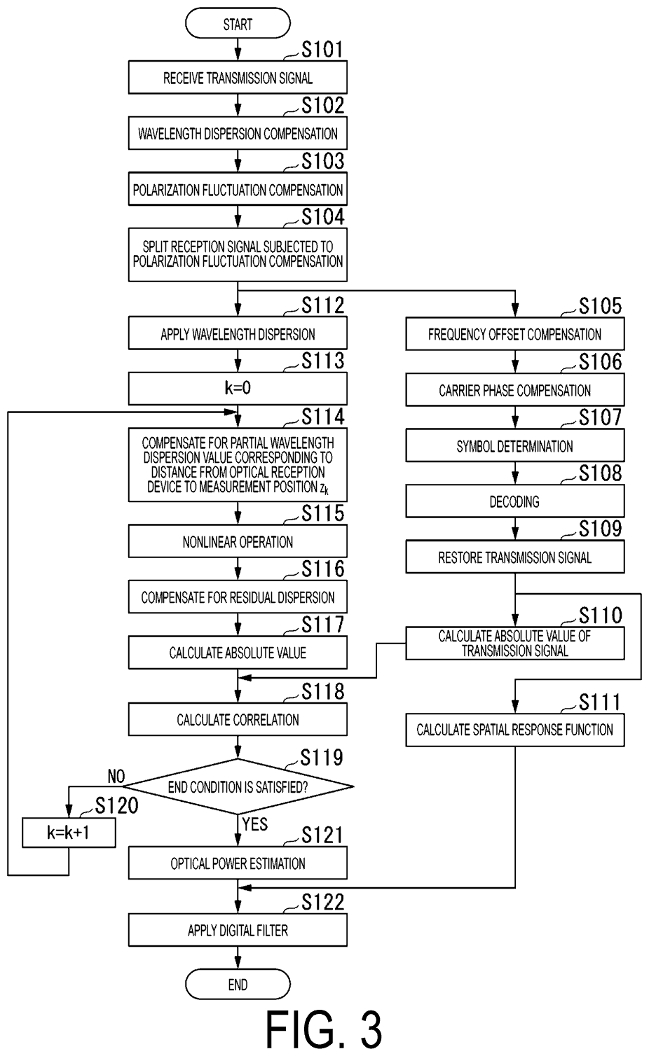

FIG. 3 is a flowchart showing a flow of processing of the optical reception device 10 according to the first embodiment.

The coherent receiver 11 receives a transmission signal transmitted from the optical transmission device via the optical transmission line (step S101). The coherent receiver 11 outputs the received reception signal to the demodulation decoding unit 12. The wavelength dispersion compensation unit 121 of the demodulation decoding unit 12 compensates for wavelength dispersion of the reception signal output from the coherent receiver 11 (step S102). The wavelength dispersion compensation unit 121 outputs the reception signal whose wavelength dispersion has been compensated for to the polarization fluctuation compensation unit 122. The polarization fluctuation compensation unit 122 compensates for distortion generated in a waveform of the reception signal in the optical transmission line by using the reception signal whose wavelength dispersion has been compensated for and which has been output from the wavelength dispersion compensation unit 121 (step S103). The polarization fluctuation compensation unit 122 splits the reception signal whose polarization fluctuation has been compensated for into the frequency offset compensation unit 123 and the wavelength dispersion application unit 14 and outputs the split reception signals thereto (step S104).

The frequency offset compensation unit 123 compensates for a frequency offset with respect to the reception signal compensated by the polarization fluctuation compensation unit 122 (step S105). The frequency offset compensation unit 123 outputs the reception signal whose frequency offset has been compensated for to the carrier phase compensation unit 124. The carrier phase compensation unit 124 compensates for a phase offset with respect to the reception signal whose frequency offset has been compensated for by the frequency offset compensation unit 123 (step S106). The carrier phase compensation unit 124 outputs the reception signal whose phase offset has been compensated for to the symbol determination unit 125.

The symbol determination unit 125 performs symbol determination on the reception signal whose phase offset has been compensated for (step S107). The symbol determination unit 125 outputs a result of the symbol determination to the decoding unit 126. The decoding unit 126 decodes the reception signal on the basis of the result of the symbol determination by the symbol determination unit 125 (step S108). The decoding unit 126 outputs the decoded reception signal to the transmission signal restoration unit 13.

The transmission signal restoration unit 13 restores the transmission signal by using the reception signal decoded by the demodulation decoding unit 12 (step S109). The transmission signal restoration unit 13 outputs the restored transmission signal to the absolute value calculation unit 15 and the spatial response function calculation unit 17. The absolute value calculation unit 15 takes an absolute value of the transmission signal restored by the transmission signal restoration unit 13 (step S110). The absolute value calculation unit 15 outputs the transmission signal whose absolute value has been taken to the optical power distribution estimation unit 16.

The spatial response function calculation unit 17 calculates the spatial response function g_{Re}(z) on the basis of Equation (2) above by using the restored transmission signal output from the transmission signal restoration unit 13 (step S111). The spatial response function calculation unit 17 outputs the spatial response function g_{Re}(z) to the digital filter application unit 18. The wavelength dispersion application unit 14 estimates wavelength dispersion received in the optical transmission line and applies a value of the estimated wavelength dispersion to the reception signal output from the wavelength dispersion compensation unit 121 (step S112). The wavelength dispersion application unit 14 outputs the reception signal to which the value of the wavelength dispersion has been applied to the optical power distribution estimation unit 16.

The partial wavelength dispersion compensation unit 161 sets k=0 (step S113) and estimates a value of wavelength dispersion corresponding to a distance from the optical reception device 10 to the optical power measurement position z. For example, k=0 is satisfied in step S113, and thus, here, the partial wavelength dispersion compensation unit 161 estimates a partial wavelength dispersion value that is a value of wavelength dispersion corresponding to a distance from the optical reception device 10 to an optical power measurement position z₀. The partial wavelength dispersion compensation unit 161 compensates for the estimated partial wavelength dispersion value with respect to the reception signal to which the value of the wavelength dispersion has been applied and which has been output from the wavelength dispersion application unit 14 (step S114). The partial wavelength dispersion compensation unit 161 outputs the reception signal whose partial wavelength dispersion value has been compensated for to the nonlinear operation unit 162.

The nonlinear operation unit 162 performs nonlinear operation based on Equation (7) above by using the reception signal whose partial wavelength dispersion value has been compensated for and which has been output from the partial wavelength dispersion compensation unit 161 (step S115). The nonlinear operation unit 162 outputs the reception signal subjected to the nonlinear operation to the residual dispersion compensation unit 163. The residual dispersion compensation unit 163 estimates a value of wavelength dispersion corresponding to a distance from the optical power measurement position zₖ to the optical transmission device. For example, the residual dispersion compensation unit 163 estimates a residual wavelength dispersion value that is a value of wavelength dispersion corresponding to a distance from the optical power measurement position z₀ to the optical transmission device. The residual dispersion compensation unit 163 compensates for the estimated residual wavelength dispersion value with respect to the reception signal subjected to the nonlinear operation and output from the nonlinear operation unit 162 (step S116). The residual dispersion compensation unit 163 outputs the reception signal whose residual wavelength dispersion value has been compensated for to the absolute value calculation unit 164.

The absolute value calculation unit 164 takes an absolute value of the reception signal whose residual wavelength dispersion has been compensated for (step S117). The absolute value calculation unit 164 outputs the reception signal whose absolute value has been taken to the correlation calculation unit 165. The correlation calculation unit 165 correlates the transmission signal whose absolute value has been taken and which has been output from the absolute value calculation unit 15 with the reception signal whose absolute value has been taken and which has been output from the absolute value calculation unit 164 (step S118). Thereafter, the correlation calculation unit 165 determines whether or not an end condition is satisfied (step S119). Here, the end condition is a condition for ending calculation of the correlation and may be, for example, that the calculation of the correlation from all the optical power measurement positions is completed.

When determining that the end condition is not satisfied (step S119: NO), the correlation calculation unit 165 adds a value 1 to k (step S120). Thereafter, the optical reception device 10 repeatedly executes the processing in step S114 and subsequent steps. For example, when the added value is k=1, the partial wavelength dispersion compensation unit 161 estimates a value of partial wavelength dispersion corresponding to a distance from the optical reception device 10 to an optical power measurement position z₁ in the processing of step S114. The partial wavelength dispersion compensation unit 161 compensates for the estimated partial wavelength dispersion value with respect to the reception signal to which the wavelength dispersion has been applied and which has been output from the wavelength dispersion application unit 14.

Thereafter, the processing from steps S115 to S118 is executed with k=1. Thereafter, the correlation calculation unit 165 determines whether or not the end condition is satisfied again (step S119). As described above, the processing from step S114 to step S118 is repeatedly executed until the correlation is acquired at all the optical power measurement positions.

In the processing of step S119, when determining that the end condition is satisfied (step S119—YES), the correlation calculation unit 165 performs optical power estimation by using the correlation result acquired for each optical power measurement position (step S121). Specifically, the correlation calculation unit 165 estimates the estimated power distribution ˜γ′(zₖ) by plotting the correlation result acquired for each optical power measurement position. The correlation calculation unit 165 outputs the estimated power distribution ˜γ′(zₖ) thus estimated to the digital filter application unit 18.

The digital filter application unit 18 obtains an ideal output by applying a digital filter to the estimated power distribution ˜γ′(zₖ) on the basis of the spatial response function g_{Re}(z) calculated by the spatial response function calculation unit 17 in the processing of step S111 and the estimated power distribution ˜γ′(zₖ) output from the correlation calculation unit 165 (step S122).

According to the optical reception device 10 configured as described above, it is possible to estimate an optical power distribution having high spatial resolution with high accuracy in the optical power distribution estimation technique by digital signal processing. Specifically, the optical reception device 10 includes: the optical power distribution estimation unit 16 that estimates an optical power distribution on the basis of a reception signal based on an optical signal transmitted from an optical transmission device and received via an optical transmission line and a transmission signal restored based on the reception signal; the spatial response function calculation unit 17 that calculates a spatial response function on the basis of the transmission signal and a dispersion value of the optical transmission line; and the digital filter application unit 18 that obtains an ideal output by applying a digital filter based on the spatial response function to the optical power distribution. As described above, the optical reception device 10 calculates a spatial response function in advance and designs a digital filter by using the calculated spatial response function. The optical reception device 10 can cancel the spatial response function by convolving the designed digital filter with the estimated optical power distribution. As a result, the optical reception device 10 acquires a true power distribution that is an ideal output. Therefore, it is possible to estimate an optical power distribution having high spatial resolution with high accuracy in the optical power distribution estimation technique by digital signal processing.

### Modification Example 1

The order of the compensation by the demodulation decoding unit 12 is not limited to the above order. The order of the compensation by the demodulation decoding unit 12 may be any order.

### Modification Example 2

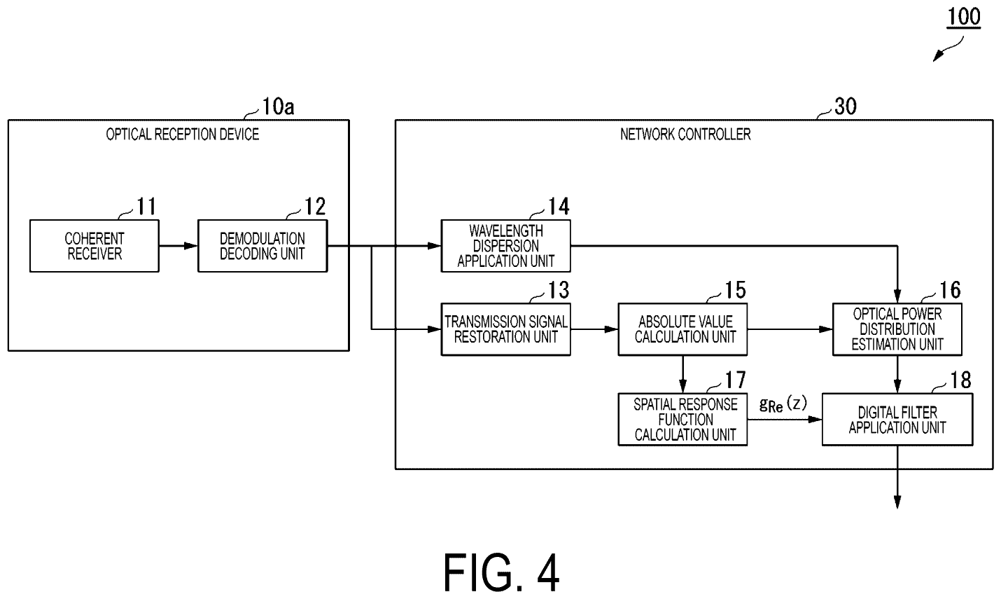

The optical power distribution estimation device included in the optical reception device 10 may be included in another device. The another device is, for example, a network controller that manages the optical transmission system. FIG. 4 shows a configuration example of an optical transmission system 100 according to a modification example of the first embodiment. The optical transmission system 100 includes an optical transmission device (not shown), an optical reception device 10a, and a network controller 30. The optical transmission system 100 may include a plurality of optical reception devices 10a. The optical transmission device (not shown) and the optical reception device 10a are connected by an optical transmission line, and the optical reception device 10a and the network controller 30 are connected by an electric line. The optical reception device 10a receives a transmission signal transmitted from the optical transmission device connected via the optical transmission line. The network controller 30 is a host device that manages the optical transmission system 100.

The optical reception device 10a includes the coherent receiver 11 and the demodulation decoding unit 12. The network controller 30 includes the transmission signal restoration unit 13, the wavelength dispersion application unit 14, the absolute value calculation unit 15, the optical power distribution estimation unit 16, the spatial response function calculation unit 17, and the digital filter application unit 18. Processing performed by the transmission signal restoration unit 13, the wavelength dispersion application unit 14, the absolute value calculation unit 15, the optical power distribution estimation unit 16, the spatial response function calculation unit 17, and the digital filter application unit 18 is basically the same as that of the functional units having the same names in FIG. 2. Hereinafter, differences will be described.

The coherent receiver 11 outputs the reception signal to the demodulation decoding unit 12. The demodulation decoding unit 12 outputs the reception signal whose wavelength dispersion has been compensated for to the wavelength dispersion application unit 14 included in the network controller 30 via the electric line and outputs the decoded reception signal to the transmission signal restoration unit 13 included in the network controller 30 via the electric line.

Each functional unit included in the network controller 30 performs processing similar to that in the first embodiment.

According to the optical transmission system 100 configured as described above, the network controller 30 serving as a host device that manages the optical transmission system 100 estimates an optical power distribution and calculates an ideal output. This makes it possible to reduce a processing load of one optical reception device 10a.

Further, in a case where a plurality of optical reception devices 10a is connected to the network controller 30, the network controller 30 can estimate the optical power distribution and calculate the ideal output for each optical reception device 10a. Therefore, it is unnecessary to estimate the optical power distribution or calculate the ideal output in each optical reception device 10a, and thus each optical reception device 10a does not need to have a function of estimating the optical power distribution or a function of calculating the ideal output. Further, one network controller 30 estimates the optical power distributions and calculates the ideal outputs for the plurality of optical reception devices 10a, and thus it is possible to efficiently perform the processing.

### Second Embodiment

In a second embodiment, a configuration for estimating an optical power distribution by using a correlation method other than the conventional correlation method will be described. Specifically, in the second embodiment, nonlinear operation that does not include the offset P₀ generated in the conventional correlation method is performed. In the conventional correlation method, Equation (7) is used for the nonlinear operation, and the offset P₀ is generated due to a constant term (=1) when exp in Equation (7) is Taylor-expanded. When the offset P₀ is generated, an amount of power change cannot be estimated. In the second embodiment, only the linear term obtained by Taylor-expanding Equation (7) is used for the nonlinear operation. This makes it possible to estimate the amount of power change.

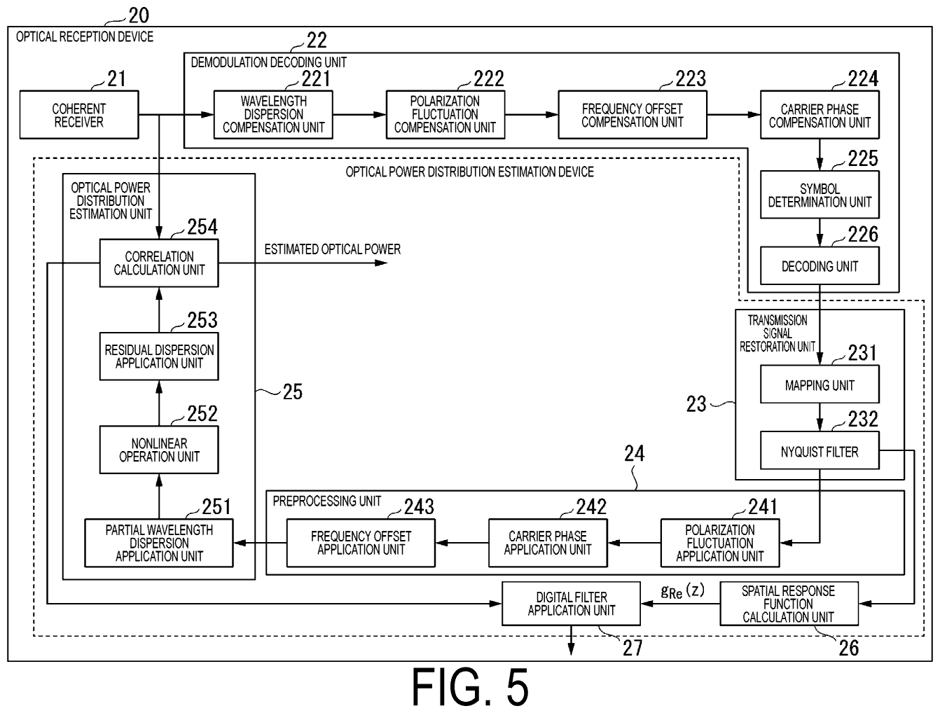

FIG. 5 shows a configuration example of an optical reception device 20 according to the second embodiment. The optical reception device 20 is connected to an optical transmission device included in an optical transmission system via an optical transmission line. The optical reception device 20 receives a transmission signal transmitted from the optical transmission device via the optical transmission line. The optical reception device 20 includes a coherent receiver 21, a demodulation decoding unit 22, a transmission signal restoration unit 23, a preprocessing unit 24, and an optical power distribution estimation unit 25. Note that the transmission signal restoration unit 23, the preprocessing unit 24, and the optical power distribution estimation unit 25 are configured as an optical power distribution estimation device. Note that processing performed by the coherent receiver 21, the demodulation decoding unit 22, and the transmission signal restoration unit 23 is basically similar to that performed by the coherent receiver 11, the demodulation decoding unit 12, and the transmission signal restoration unit 13 in the first embodiment. Therefore, differences from the first embodiment will be mainly described.

The preprocessing unit 24 performs predetermined processing on the transmission signal restored by the transmission signal restoration unit 23. Here, the predetermined processing is processing of applying a value corresponding to the influence caused by the optical transmission line to the transmission signal in order to bring the transmission signal close to the reception signal. The preprocessing unit 24 includes a polarization fluctuation application unit 241, a carrier phase application unit 242, and a frequency offset application unit 243.

The polarization fluctuation application unit 241 applies the same value as the distortion generated in the waveform of the reception signal compensated for by the polarization fluctuation compensation unit 222 to the transmission signal restored by the transmission signal restoration unit 23.

The carrier phase application unit 242 applies the same value as the phase offset compensated for by the carrier phase compensation unit 224 to the transmission signal to which the same value as the distortion has been applied by the polarization fluctuation application unit 241.

The frequency offset application unit 243 applies the same value as that of the frequency offset compensated for by the frequency offset compensation unit 223 to the transmission signal to which the same value as the phase offset has been applied by the carrier phase application unit 242. As described above, the preprocessing unit 24 generates a signal in which a value of the wavelength dispersion has been removed from the reception signal received by the coherent receiver 21. Hereinafter, the transmission signal processed by the preprocessing unit 24 will be referred to as a preprocessed transmission signal.

The optical power distribution estimation unit 25 estimates an optical power distribution (optical transmission characteristic) of the optical transmission line by an estimation algorithm based on a correlation method. The optical power distribution estimation unit 25 includes a partial wavelength dispersion application unit 251, a nonlinear operation unit 252, a residual dispersion application unit 253, and a correlation calculation unit 254.

The partial wavelength dispersion application unit 251 applies a partial wavelength dispersion value to the preprocessed transmission signal.

The nonlinear operation unit 252 performs nonlinear operation on the transmission signal to which the value of the partial wavelength dispersion has been applied by the partial wavelength dispersion application unit 251. More specifically, the nonlinear operation unit 252 performs nonlinear operation based on Equation (8) using a linear term obtained by Taylor-expanding a mathematical expression used for phase rotation on the transmission signal to which the value of the partial wavelength dispersion has been applied. Equation (8) is an equation using a linear term of the Taylor expansion of the conventional nonlinear operation unit 162. In Equation (8), uₒᵤₜ denotes an output from the nonlinear operation unit 252, and uᵢₙ denotes the transmission signal to which the value of the partial wavelength dispersion has been applied.

$$\begin{matrix}[ Math . 8 ] & \\ {u}_{out} = {u}_{in} \cdot ( - j ε ( {\vert {u}_{in , x} \vert}^{2} + {\vert {u}_{in , y} \vert}^{2} ) ) & Equation ( 8 )\end{matrix}$$

$$( {u}_{in} = [ \begin{matrix}{u}_{in , x} \\ {u}_{in , y}\end{matrix} ] , {u}_{out} = [ \begin{matrix}{u}_{out , x} \\ {u}_{out , y}\end{matrix} ] , ε is arbitrary real number set by user )$$

The residual dispersion application unit 253 applies a residual wavelength dispersion value to the transmission signal subjected to the nonlinear operation.

The correlation calculation unit 254 correlates the reception signal output from the coherent receiver 21 with the transmission signal to which the residual wavelength dispersion value has been applied and which has been output from the residual dispersion application unit 253. The correlation calculation unit 254 performs this processing for each optical power measurement position. The correlation calculation unit 254 estimates the estimated power distribution ˜γ′(zₖ) by plotting a correlation result (correlation value) obtained for each optical power measurement position. At this time, the estimated power output from the correlation calculation unit 254 is a complex value. When plotting, the correlation calculation unit takes a real part of the estimated power or takes an absolute value and then performs plotting.

The spatial response function calculation unit 26 calculates the spatial response function g_{Re}(z) on the basis of Equation (2) above by using the transmission signal restored by the transmission signal restoration unit 23.

The digital filter application unit 27 designs the digital filter g⁻¹_{Re}(z) by using the spatial response function g_{Re}(z) calculated by the spatial response function calculation unit 26. The digital filter application unit 27 obtains an ideal output by convolving the digital filter g⁻¹_{Re}(z) with the estimated power distribution ˜γ′(zₖ) estimated by the correlation calculation unit 254.

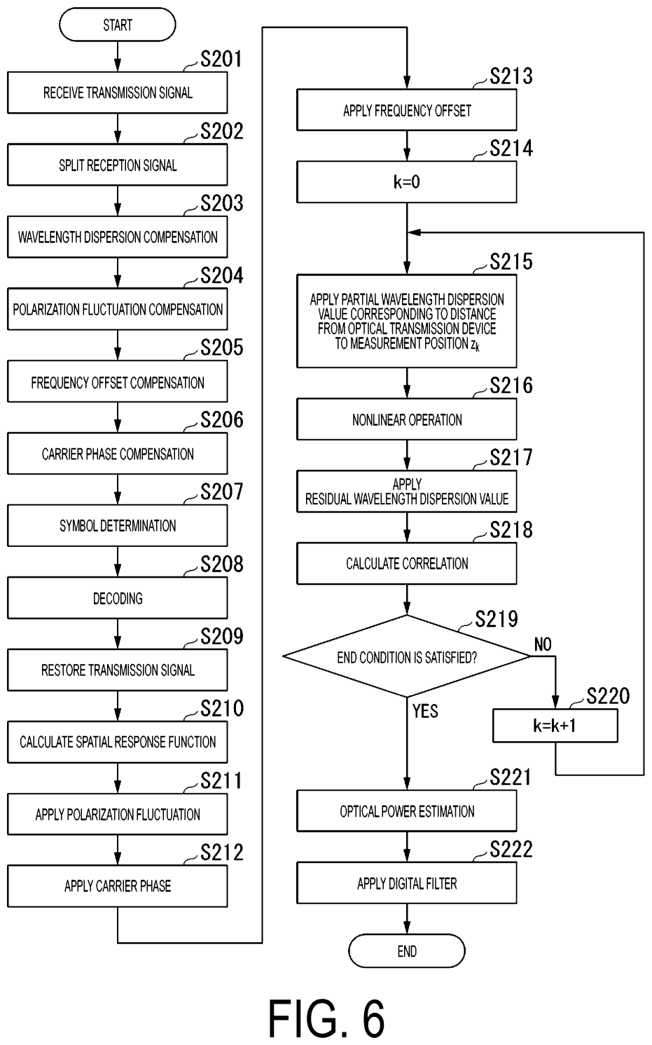

FIG. 6 is a flowchart showing a flow of processing of the optical reception device 20 according to the second embodiment.

The coherent receiver 21 receives a transmission signal transmitted from the optical transmission device via the optical transmission line (step S201). The coherent receiver 21 outputs the received reception signal. The reception signal output from the coherent receiver 21 is split and input to the demodulation decoding unit 22 and the optical power distribution estimation unit 25 (step S202).

The wavelength dispersion compensation unit 221 estimates wavelength dispersion received in the optical transmission line and compensates for the estimated wavelength dispersion with respect to the reception signal output from the coherent receiver 21 (step S203). The wavelength dispersion compensation unit 221 outputs the reception signal whose wavelength dispersion has been compensated for to the polarization fluctuation compensation unit 222. The polarization fluctuation compensation unit 222 compensates for distortion generated in a waveform of the reception signal in the optical transmission line by using the reception signal whose wavelength dispersion has been compensated for and which has been output from the wavelength dispersion compensation unit 221 (step S204). The polarization fluctuation compensation unit 222 outputs the compensated reception signal to the frequency offset compensation unit 223.

The frequency offset compensation unit 223 compensates for a frequency offset with respect to the reception signal compensated by the polarization fluctuation compensation unit 222 (step S205). The frequency offset compensation unit 223 outputs the reception signal whose frequency offset has been compensated for to the carrier phase compensation unit 224. The carrier phase compensation unit 224 compensates for a phase offset with respect to the reception signal whose frequency offset has been compensated for by the frequency offset compensation unit 223 (step S206). The carrier phase compensation unit 224 outputs the reception signal whose phase offset has been compensated for to the symbol determination unit 225.

The symbol determination unit 225 performs symbol determination on the reception signal whose phase offset has been compensated for (step S207). The symbol determination unit 225 outputs a result of the symbol determination to the decoding unit 226. The decoding unit 226 decodes the reception signal on the basis of the result of the symbol determination by the symbol determination unit 225 (step S208). The decoding unit 226 outputs the decoded reception signal to the transmission signal restoration unit 23.

The transmission signal restoration unit 23 restores the transmission signal by using the reception signal decoded by the demodulation decoding unit 22 (step S209). The transmission signal restoration unit 23 outputs the restored transmission signal to the preprocessing unit 24 and the spatial response function calculation unit 26. The spatial response function calculation unit 26 calculates the spatial response function g_{Re}(z) on the basis of Equation (2) above by using the transmission signal output from the transmission signal restoration unit 23 (step S210). The spatial response function calculation unit 26 outputs the spatial response function g_{Re}(z) to the digital filter application unit 27.

The polarization fluctuation application unit 241 applies the same value as the distortion generated in the waveform of the reception signal compensated for by the polarization fluctuation compensation unit 222 to the transmission signal restored by the transmission signal restoration unit 23 (step S211). The polarization fluctuation application unit 241 outputs the transmission signal after the application to the carrier phase application unit 242.

The carrier phase application unit 242 applies the same value as the phase offset compensated for by the carrier phase compensation unit 224 to the transmission signal after the application, which is output from the polarization fluctuation application unit 241 (step S212). The carrier phase application unit 242 outputs the transmission signal after the application to the frequency offset application unit 243. The frequency offset application unit 243 applies the same value as that of the frequency offset compensated for by the frequency offset compensation unit 223 to the transmission signal after the application, which is output from the carrier phase application unit 242 (step S213). The frequency offset application unit 243 outputs the transmission signal after the application to the optical power distribution estimation unit 25.

The partial wavelength dispersion application unit 251 sets k=0 (step S214) and estimates a value of wavelength dispersion corresponding to a distance from the optical transmission device to the optical power measurement position zₖ. For example, k=0 is satisfied in step S214, and thus, here, the partial wavelength dispersion application unit 251 estimates a partial wavelength dispersion value that is a value of wavelength dispersion corresponding to a distance from the optical transmission device to the optical power measurement position z₀. The partial wavelength dispersion application unit 251 applies the estimated partial wavelength dispersion value to the transmission signal after the application, which is output from the frequency offset application unit 243 (step S215). The partial wavelength dispersion application unit 251 outputs the transmission signal to which the partial wavelength dispersion value has been applied to the nonlinear operation unit 252.

The nonlinear operation unit 252 performs nonlinear operation based on Equation (8) above by using the transmission signal after the application of the partial wavelength dispersion value, which is output from the partial wavelength dispersion application unit 251 (step S216). The nonlinear operation unit 252 outputs the transmission signal subjected to the nonlinear operation to the residual dispersion application unit 253. The residual dispersion application unit 253 estimates a value of wavelength dispersion corresponding to a distance from the optical power measurement position zₖ to the optical reception device 20. For example, the residual dispersion application unit 253 estimates a residual wavelength dispersion value that is a value of wavelength dispersion corresponding to a distance from the optical power measurement position z₀ to the optical reception device 20. The residual dispersion application unit 253 applies the estimated residual wavelength dispersion value to the transmission signal subjected to the nonlinear operation and output from the nonlinear operation unit 252 (step S217). The residual dispersion application unit 253 outputs the transmission signal to which the residual wavelength dispersion value has been applied to the correlation calculation unit 254.

The correlation calculation unit 254 correlates the reception signal output from the coherent receiver 21 with the transmission signal after the application of the residual wavelength dispersion value, which is output from the residual dispersion application unit 253 (step S218). Thereafter, the correlation calculation unit 254 determines whether or not an end condition is satisfied (step S219). Here, the end condition is a condition for ending calculation of the correlation and may be, for example, that the calculation of the correlation from all the optical power measurement positions is completed.

When determining that the end condition is not satisfied (step S219: NO), the correlation calculation unit 254 adds a value 1 to k (step S220). Thereafter, the optical reception device 20 repeatedly executes the processing in step S215 and subsequent steps. For example, when the added value is k=1, a value of partial wavelength dispersion corresponding to a distance from the optical transmission device to the optical power measurement position z₁ is estimated in the processing of step S215. The partial wavelength dispersion application unit 251 applies the estimated partial wavelength dispersion value to the transmission signal after the application, which is output from the frequency offset application unit 243.

Thereafter, the processing from steps S215 to S218 is executed with k=1. Thereafter, the correlation calculation unit 254 determines whether or not the end condition is satisfied again (step S219). As described above, the processing from step S215 to step S218 is repeatedly executed until the correlation is acquired at all the optical power measurement positions.

In the processing of step S219, when determining that the end condition is satisfied (step S219—YES), the correlation calculation unit 254 performs optical power estimation by using the correlation result acquired for each optical power measurement position (step S221). Specifically, the correlation calculation unit 254 estimates the estimated power distribution ˜γ′(zₖ) by plotting the correlation result acquired for each optical power measurement position. The correlation calculation unit 254 outputs the estimated power distribution ˜γ′(zₖ) thus estimated to the digital filter application unit 27.

The digital filter application unit 27 obtains an ideal output by applying a digital filter to the estimated power distribution ˜γ′(zₖ) on the basis of the spatial response function g_{Re}(z) calculated by the spatial response function calculation unit 26 and the estimated power distribution ˜γ′(zₖ) output from the correlation calculation unit 254 (step S222).

According to the optical reception device 20 configured as described above, effects similar to those of the first embodiment can be obtained.

### Modification Example 1

The order of the compensation by the demodulation decoding unit 22 and the order of the application by the preprocessing unit 24 and the optical power distribution estimation unit 25 are not limited to the above orders. The order of the compensation by the demodulation decoding unit 22 may be any order. The above embodiment shows a configuration in which the values corresponding to the polarization fluctuation, the frequency offset, and the carrier phase are applied to the restored transmission signal in the preprocessing unit 24, but the values corresponding to the polarization fluctuation, the frequency offset, and the carrier phase only need to be applied before the processing is performed by the correlation calculation unit 254.

### Modification Example 2

In the above embodiment, the processing of taking an absolute value may be performed before the correlation calculation is performed as in the first embodiment.

### Modification Example 3

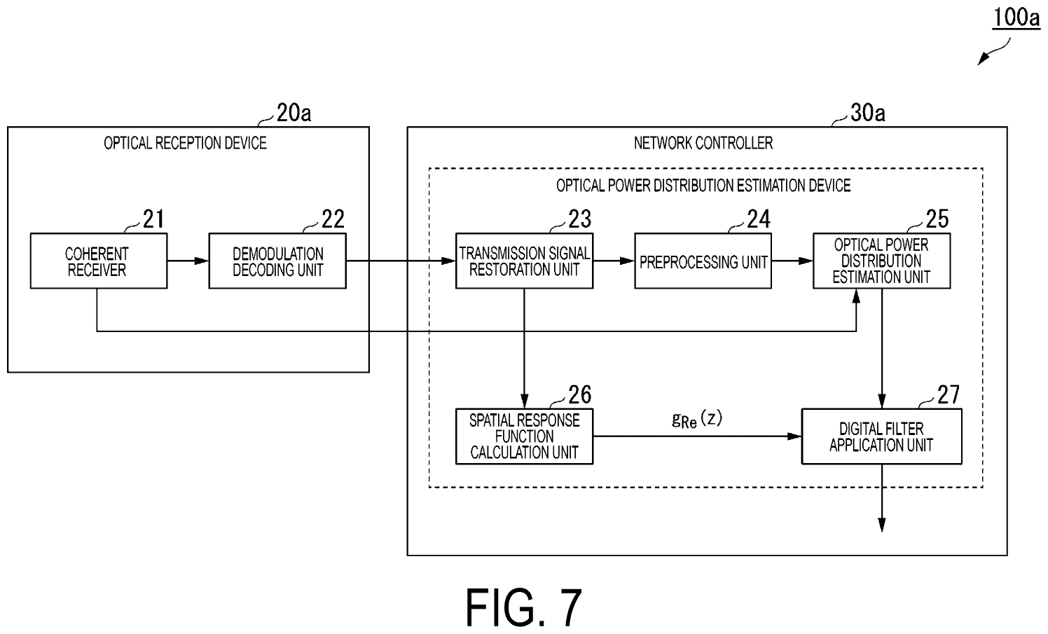

The optical power distribution estimation device included in the optical reception device 20 may be included in another device. FIG. 7 shows a configuration example of an optical transmission system 100a according to a modification example of the second embodiment. The optical transmission system 100a includes an optical transmission device (not shown), an optical reception device 20a, and a network controller 30a. The optical transmission system 100a may include a plurality of optical reception devices 20a. The optical transmission device (not shown) and the optical reception device 20a are connected by an optical transmission line, and the optical reception device 20a and the network controller 30a are connected by an electric line. The optical reception device 20a receives a transmission signal transmitted from an optical transmission device connected via an optical transmission line. The network controller 30a is a host device that manages the optical transmission system 100a.

The optical reception device 20a includes the coherent receiver 21 and the demodulation decoding unit 22. The network controller 30a includes the transmission signal restoration unit 23, the preprocessing unit 24, the optical power distribution estimation unit 25, the spatial response function calculation unit 26, and the digital filter application unit 27. Processing performed by the transmission signal restoration unit 23, the preprocessing unit 24, the optical power distribution estimation unit 25, the spatial response function calculation unit 26, and the digital filter application unit 27 is basically the same as that of the functional units having the same names in FIG. 5. Hereinafter, differences will be described.

The coherent receiver 21 outputs a reception signal to the demodulation decoding unit 22 and also to the optical power distribution estimation unit 25 included in the network controller 30 via the electric line. The demodulation decoding unit 22 outputs the decoded reception signal to the transmission signal restoration unit 23 included in the network controller 30 via the electric line.

The functional units included in the network controller 30 perform processing similar to that of the functional units having the same names in the second embodiment.

According to the optical transmission system 100a configured as described above, effects similar to those of the modification example 2 of the first embodiment can be obtained.

### Third Embodiment

In a third embodiment, a configuration for estimating an optical power distribution by using the least squares method will be described. The optical power distribution ˜γ′(zₖ) estimated by the least squares method is shown in Equation (9) below. The symbol F in Equation (9) denotes Fourier transform.

$$\begin{matrix}[ Math . 9 ] & \\ {\tilde{γ}}^{′} ( {z}_{k} ) = \frac{1}{Δ z} \cdot {F}^{- 1} [ \frac{F [ ( {γ}^{′} {⊗}_{c} {g}_{Re} ) ( {z}_{k} ) ]}{F [ {g}_{Re} ( {z}_{k} ) ]} ] & Equation ( 9 )\end{matrix}$$

The symbol Az denotes an estimated spatial granularity. As in the first embodiment and the second embodiment, it can be considered that an optical power distribution estimated by using the least squares method is “convolution of a certain spatial response function g_{Re}(z) with a true optical power distribution γ′(z) (or one proportional thereto)”. Therefore, if the spatial response function g_{Re}(z) is known in advance, the true optical power distribution γ′(z) can be restored. Hereinafter, a specific configuration for obtaining the true optical power distribution γ′(z) will be described on the basis of results based on the above consideration.

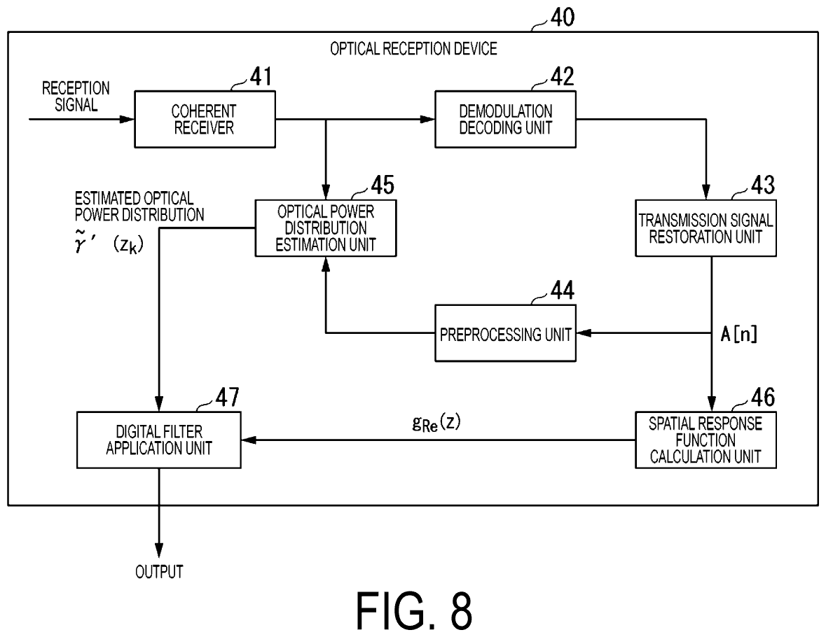

FIG. 8 shows a configuration example of an optical reception device 40 according to the third embodiment. The optical reception device 40 uses the least squares method as an estimation algorithm for estimating an optical power distribution. The optical reception device 40 is connected to an optical transmission device included in an optical transmission system via an optical transmission line. The optical reception device 40 receives a transmission signal transmitted from the optical transmission device via the optical transmission line. The optical reception device 40 includes a coherent receiver 41, a demodulation decoding unit 42, a transmission signal restoration unit 43, a preprocessing unit 44, an optical power distribution estimation unit 45, a spatial response function calculation unit 46, and a digital filter application unit 47. Note that the transmission signal restoration unit 43, the preprocessing unit 44, the optical power distribution estimation unit 45, the spatial response function calculation unit 46, and the digital filter application unit 47 are configured as an optical power distribution estimation device.

The coherent receiver 41, the demodulation decoding unit 42, the transmission signal restoration unit 43, and the preprocessing unit 44 perform processing similar to that of the functional units having the same names in the first and second embodiments described above, and thus the description thereof will be omitted.

The optical power distribution estimation unit 45 estimates the optical power distribution (optical transmission characteristic) ˜γ′(zₖ) of the optical transmission line by the estimation algorithm based on the least squares method. A method of estimating the optical power distribution (optical transmission characteristic) of the optical transmission line by the estimation algorithm based on the least squares method is an existing method, and thus the description thereof will be omitted. For example, the method of estimating the optical power distribution (optical transmission characteristic) of the optical transmission line by the estimation algorithm based on the least squares method may be a method disclosed in Non Patent Literature 2 or Reference Literature 1. (Reference Literature 1: Takeo Sasai, Etsushi Yamazaki, Masanori Nakamura, and Yoshiaki Kisaka, “Proposal of Linear Least Squares for Fiber-Nonlinearity-Based Longitudinal Power Monitoring in Multi-Span Link”, OECC/PSC 2022)

The spatial response function calculation unit 46 calculates the spatial response function g_{Re}(z) on the basis of Equation (2) above by using a transmission signal restored by the transmission signal restoration unit 43.

The digital filter application unit 47 designs the digital filter g⁻¹_{Re}(z) by using the spatial response function g_{Re}(z) calculated by the spatial response function calculation unit 46. The digital filter application unit 47 obtains an ideal output by convolving the digital filter g⁻¹_{Re}(z) with the estimated power distribution ˜γ′(zₖ) estimated by the optical power distribution estimation unit 45.

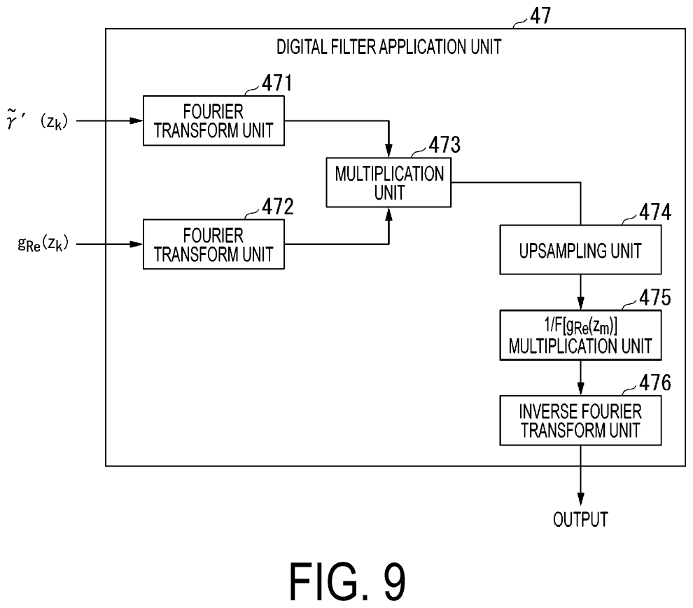

FIG. 9 shows a configuration example of the digital filter application unit 47 according to the third embodiment. The digital filter application unit 47 includes Fourier transform units 471 and 472, a multiplication unit 473, an upsampling unit 474, a 1/F[g_{Re}(zₘ)] multiplication unit 475, and an inverse Fourier transform unit 476.

The Fourier transform unit 471 receives the estimated power distribution ˜γ′(zₖ) estimated by the optical power distribution estimation unit 45 as an input. The Fourier transform unit 471 performs the Fourier transform on the input estimated power distribution ˜γ′(zₖ). Hereinafter, the estimated power distribution ˜γ′(zₖ) subjected to the Fourier transform is denoted by F[˜γ′(zₖ)].

The Fourier transform unit 472 receives the spatial response function g_{Re}(z) calculated by the spatial response function calculation unit 46 as an input. The Fourier transform unit 472 performs the Fourier transform on the input spatial response function g_{Re}(z). Hereinafter, the spatial response function g_{Re}(z) subjected to the Fourier transform is denoted by F[g_{Re}(z)].

The multiplication unit 473 multiplies the result F[˜γ′(zₖ)] of the Fourier transform by the Fourier transform unit 471 and the result F[g_{Re}(z)] of the Fourier transform by the Fourier transform unit 472. A result obtained by the multiplication unit 473 is shown in Equation (10) below.

$$\begin{matrix}[ Math . 10 ] & \\ Δ z \cdot F [ {\tilde{γ}}^{′} ( {z}_{k} ) ] \cdot F [ {g}_{Re} ( {z}_{k} ) ] & Equation ( 10 )\end{matrix}$$

The upsampling unit 474 upsamples the result obtained by the multiplication unit 473.

The 1/F[g_{Re}(zₘ)] multiplication unit 475 multiplies a value upsampled by the upsampling unit 474 by 1/F[g_{Re}(zₘ)]. Here, zₘ (m=0, 1, . . . , M) denotes a position with finer granularity than the optical power measurement position zₖ. That is, the 1/F[g_{Re}(zₘ)] multiplication unit 475 multiplies the value upsampled by the upsampling unit 474 by a reciprocal of a value obtained by performing the Fourier transform on the spatial response function at the position with finer granularity than the optical power measurement position zₖ.

The inverse Fourier transform unit 476 performs the inverse Fourier transform on the multiplication result by the 1/F[g_{Re}(zₘ)] multiplication unit 475. Therefore, the digital filter application unit 47 obtains an ideal output.

According to the optical reception device 40 configured as described above, effects similar to those of the first embodiment can be obtained even in a configuration using the least squares method as the optical power distribution estimation technique.

### Modification Example 1

The order of the compensation by the demodulation decoding unit 42 is not limited to the above order. The order of the compensation by the demodulation decoding unit 42 may be any order.

### Modification Example 2

The optical power distribution estimation device included in the optical reception device 40 may be included in another device. The another device is, for example, a network controller that manages the optical transmission system. In such a configuration, the optical reception device 40 includes the coherent receiver 41 and the demodulation decoding unit 42. The network controller includes the transmission signal restoration unit 43, the preprocessing unit 44, the optical power distribution estimation unit 45, the spatial response function calculation unit 46, and the digital filter application unit 47. Processing performed by the transmission signal restoration unit 43, the preprocessing unit 44, the optical power distribution estimation unit 45, the spatial response function calculation unit 46, and the digital filter application unit 47 is basically the same as that of the functional units having the same names in FIG. 8. Hereinafter, differences will be described.

The coherent receiver 41 outputs a reception signal to the demodulation decoding unit 42 and also to the optical power distribution estimation unit 45 included in the network controller via an electric line. The demodulation decoding unit 42 outputs the decoded reception signal to the transmission signal restoration unit 43 included in the network controller via the electric line.

The functional units included in the network controller 30 perform processing similar to that of the functional units having the same names in the third embodiment.

Some or all of the functional units of the optical reception devices 10, 10a, 20, 20a, and 40 and the network controllers 30 and 30a described above are implemented as software by causing a processor such as a central processing unit (CPU) to execute a program stored in a storage device including a nonvolatile recording medium (non-transitory recording medium) and a storage unit. The program may be recorded in a computer-readable non-transitory recording medium. The computer-readable non-transitory recording medium is a non-transitory recording medium such as a portable medium including, for example, a flexible disk, a magneto-optical disk, a read only memory (ROM), and a compact disc read only memory (CD-ROM) or a storage device such as a hard disk built in a computer system.

Some or all of the functional units of the optical reception devices 10, 10a, 20, 20a, and 40 and the network controllers 30 and 30a described above may be implemented by using hardware including an electronic circuit (or circuitry) including, for example, a large scale integrated circuit (LSI), an application specific integrated circuit (ASIC), a programmable logic device (PLD), or a field programmable gate array (FPGA).

Although the embodiments of the present invention have been described in detail with reference to the drawings, specific configurations are not limited to the embodiments and include design and the like within the gist of the present invention.

### INDUSTRIAL APPLICABILITY

The present invention can be applied to a technique of estimating transmission characteristics in a digital coherent optical transmission system.

### REFERENCE SIGNS LIST

10, 10a, 20, 20a, 40 Optical reception device
11, 21, 41 Coherent receiver
12, 22, 42 Demodulation decoding unit
13, 23, 43 Transmission signal restoration unit
14 Wavelength dispersion application unit
15, 164 Absolute value calculation unit
16, 25, 45 Optical power distribution estimation unit
17, 26, 46 Spatial response function calculation unit
18, 27, 47 Digital filter application unit
24, 44 Preprocessing unit
30, 30a Network controller
121, 221 Wavelength dispersion compensation unit
122, 222 Polarization fluctuation compensation unit
123, 223 Frequency offset compensation unit
124, 224 Carrier phase compensation unit
125, 225 Symbol determination unit
126, 226 Decoding unit
131, 231 Mapping unit
132, 232 Nyquist filter
161 Partial wavelength dispersion compensation unit
162, 252 Nonlinear operation unit
163 Residual dispersion compensation unit
241 Polarization fluctuation application unit
242 Carrier phase application unit
243 Frequency offset application unit
251 Partial wavelength dispersion application unit
253 Residual dispersion application unit
165, 254 Correlation calculation unit
471, 472 Fourier transform unit
473 Multiplication unit
474 Upsampling unit
475 1/F[g_{Re}(zₘ)] multiplication unit
476 Inverse Fourier transform unit

1. An optical power distribution estimation device comprising:
an optical power distribution estimator configured to estimate an optical power distribution on a basis of a reception signal based on an optical signal transmitted from an optical transmission device and received via an optical transmission line and a transmission signal restored based on the reception signal;
a spatial response function calculator configured to calculate a spatial response function on a basis of the transmission signal and a dispersion value of the optical transmission line; and
a digital filter applicator configured to obtain an ideal output by applying a digital filter based on the spatial response function to the optical power distribution.

2. The optical power distribution estimation device according to claim 1, wherein
the digital filter applicator obtains the ideal output by designing the digital filter by using the spatial response function calculated by the spatial response function calculator and convolving the designed digital filter with the optical power distribution.

3. The optical power distribution estimation device according to claim 1, wherein
the optical power distribution estimator estimates the optical power distribution by using a method based on a correlation method as an estimation algorithm for the optical power distribution.

4. The optical power distribution estimation device according to claim 3, wherein
the optical power distribution estimator includes
a partial wavelength dispersion applicator configured to apply, to a signal, partial wavelength dispersion corresponding to a distance from the optical transmission device to an optical power measurement position,
a nonlinear operator configured to perform, on the signal to which the partial wavelength dispersion has been applied, nonlinear operation using a linear term obtained by Taylor-expanding a mathematical expression used for phase rotation,
a residual dispersion applicator configured to apply residual wavelength dispersion corresponding to a distance from the optical power measurement position to an optical reception device to the signal subjected to the nonlinear operation by the nonlinear operator, and
a correlation calculator configured to estimate the optical power distribution of the optical transmission line by obtaining, for each optical power measurement position, a correlation between the signal to which the residual wavelength dispersion has been applied and the reception signal based on the optical signal transmitted from the optical transmission device and received via the optical transmission line.

5. The optical power distribution estimation device according to claim 1, wherein
the optical power distribution estimator estimates the optical power distribution by using a method based on the least squares method as an estimation algorithm for the optical power distribution.

6. An optical power distribution estimation method comprising:
estimating an optical power distribution on a basis of a reception signal based on an optical signal transmitted from an optical transmission device and received via an optical transmission line and a transmission signal restored based on the reception signal;
calculating a spatial response function on a basis of the transmission signal and a dispersion value of the optical transmission line; and
obtaining an ideal output by applying a digital filter based on the spatial response function to the optical power distribution.

7. A non-transitory storage medium that stores a program for making a computer perform processes, the processes comprising:
estimating an optical power distribution on a basis of a reception signal based on an optical signal transmitted from an optical transmission device and received via an optical transmission line and a transmission signal restored based on the reception signal;
calculating a spatial response function on a basis of the transmission signal and a dispersion value of the optical transmission line; and
obtaining an ideal output by applying a digital filter based on the spatial response function to the optical power distribution.
